(19) United States
(12) Patent Application Publication
(10) Pub. No.: US 2009/0083476 A1
(43) Pub. Date: Mar. 26, 2009

(54) SOLID STATE DISK STORAGE SYSTEM WITH PARALLEL ACCESSSING ARCHITECTURE AND SOLID STATE DISCK CONTROLLER

(75) Inventors: Khein-Seng Pua, Hsinchu (TW); Kian-Leng Lee, Hsinchu (TW)

Correspondence Address: J C PATENTS, INC., 4 VENTURE, SUITE 250, IRVINE, CA, 92618, US

(73) Assignee: PHISON ELECTRONICS CORP., Hsinchu (TW)

(21) Appl. No.: 11/874,080

(22) Filed: Oct. 17, 2007

(30) Foreign Application Priority Data
Sep. 21, 2007 (TW) 96135376

(51) Int. Cl. G06F 12/00

(52) U.S. Cl. 711/103

(57) ABSTRACT

A solid state disk (SSD) storage system with a parallel accessing architecture, including a SSD controller and a plurality of transmission interfaces of a predetermined bit number and bandwidth, and a solid state disk controller thereof are provided. The SD controller forms channels for transmitting control signals and data with one or more flash memories through each of the transmission interfaces. That is, independent transmission channels are constituted between the SSD controller, the transmission interfaces with multiple bits, and the flash memories. In one embodiment, the transmission interfaces are compatible with MMC 4.0 protocol or higher. Moreover, a host controls and accesses the flash memories through a SATA bus interface and the SSD controller, and uses a direct memory access (DMA) engine with a bidirectional connection port in the SSD controller to transmit data.

### CROSS-REFERENCE TO RELATED APPLICATION

This application claims the priority benefit of Taiwan application serial no. 96135376, filed on Sep. 21, 2007. All disclosure of the Taiwan application is incorporated herein by reference.

### BACKGROUND OF THE INVENTION

1. Field of the Invention

The present invention relates to a solid state disk (SSD) storage system. More particularly, the present invention relates to an SSD storage system with a parallel accessing architecture and an SSD controller.

2. Description of Related Art

With the continuous progress of data transmission technology of high-speed serial ports and parallel ports in recent years, high-speed interfaces such as Universal Serial Bus (USB) 2.0, IEEE1394, IDE Ultra DMA Mode were developed, which improve the data transmission rate significantly. However, the data transmission rate of storage devices such as flash memories does not increase along with the development, and is still much lower than that of high-speed serial ports and parallel ports. For example, USB 2.0 and IEEE1394, which are high-speed serial ports, have defined data transmission rates of 480 Mbps and 800 Mbps respectively. For example, IDE Ultra DMA mode, which is a parallel port, has a defined data transmission rate of 133 MB/s. In addition, serial ATA (SATA) bus and SATA II having much higher transmission rates than the transmission interfaces mentioned above, i.e., 150 MB/s (or 1.2 Gb/s) and 300 MB/s (or 2.4 Gb/s) respectively, are also available in market. However, the storage devices such as flash memories are limited by their physical characteristics, and have a mean transmission rate of about 5 MB/s, so a bottleneck of the data transmission rate occurs.

In addition, flash memories now are classified into single level cell (SLC) and multi level cell (MLC). A SLC uses an array to store one binary bit, and a MLC is classified according to the number of electrons, that is to say, it is capable of storing more bits in an array. Early flash memories are mostly SLCs, so they feature higher speed and lower power consumption. The MLCs have lower speed but lower cost, so they are more competitive, and are applied more widely now. Therefore, when developing products such as portable drives, MP3 players, PDAs, Pocket PCs, and digital cameras requiring high data transmission rates, it has become an important subject for manufacturers to solve the problem of low transmission rate of interfaces of the storage devices such as flash memories and to improve the overall performance

Moreover, current data transmission and storage devices are media for data transmission connected to high-speed serial ports (e.g., USB 2.0 interfaces) of computers. FIG. 1 is a schematic block diagram of the connection of a conventional storage device and a PC. Referring to FIG. 1, viewing as a whole, a serial BUS connection port 120 of the storage device is connected to a high-speed serial BUS connection port 112 of the PC 110, and the data is converted from a USB 2.0 interface to a flash memory interface by a controller 130, and is stored in a flash memory 140. Though the USB 2.0 interface is a high-speed serial port, when the data is being stored in the flash memory 140, the system must wait for the busy state of the flash memory 140, so the overall transmission rate for storage is greatly lowered, and the performance of the high-speed serial port cannot be fully used.

In addition, it has become a trend to use NAND flash memories, i.e., solid state disks (SSD) discussed herein, to replace hard drive storage devices. The main characteristics of a NAND flash memory are that a flash memory is used to replace the disk of the conventional hard drive, and an additional control chip and the interface of the conventional hard drive are used to simulate a hard drive. The NAND device has the universality of hard drives, and features the advantages of high searching efficiency, no noise, and low temperature of memories at the same time. As the NAND flash memory can reduce the inherent mechanical latency of hard drive and shorten the duty cycle, so the power consumption is lowered, and the shock and impact in operation is reduced.

For example, Microsoft puts forward the concept of hybrid drives in its latest Vista operating system, which uses the NAND flash memory to function as the cache between the operating system and the rotating hard disk. The solution described above is referred to as ReadyDrive. Moreover, in Robson technical solution developed by Intel, the NAND flash memory is arranged in an independent module closer to a microprocessor, and is mounted on the mainboard. However, the above architecture still does not achieve any improvement in terms of the transmission between the NAND flash memory module and the high-speed serial port of the computer.

In case that SATA or SATA II bus interfaces with very high transmission rates are used, the aforementioned problem will become even more serious. For example, the connection to a plurality of flash memory modules via an ATA bus architecture and then a two-level shared bus has been disclosed, as shown in FIG. 2. An ATA bus controller 250 is connected to a plurality of flash memory modules 210, 220, 230, and 240 via a shared bus 260. The ATA bus controller 250 is connected to a host ATA bus interface 282 of a host 280 via a bus 270, so as to form the transmission control architecture between the flash memory modules 210, 220, 230, 240 and the host 280. However, in such architecture, the operations such as accessing control, data, and even optimization required by the flash memories are all processed by the ATA bus controller 250, leading to lower performance between the host 280 and the shared bus architecture storage system.

In addition, as the shared bus 260 is applied, the architecture cannot connect to more flash memory modules, so expansion of the architecture cannot be realized. Apparently, this architecture cannot achieve the objective of replacing the hard drive with flash memories.

### SUMMARY OF THE INVENTION

The present invention is directed to providing a solid state disk (SSD) storage system with a parallel accessing architecture, including a SSD controller and a plurality of transmission interfaces of a predetermined bit number and bandwidth. The SSD controller form parallel channels for transmitting control signals and data with one or more flash memories through each of the transmission interfaces. That is, independent transmission channels are constituted between the SSD controller, the transmission interfaces with multiple bits, and the flash memories.

In one embodiment, the transmission interface is a Multimedia Card (MMC) control mechanism, including a MMC host controller in the SSD controller and a MMC-flash memory controller for connecting one or more flash memories. In another embodiment, a Secure Digital (SD) card control mechanism, including a SD card host controller in the SSD controller and a plurality of connections between SD and flash memory controllers, can also be selected. In another embodiment, a Compact Flash (CF) card control mechanism, including a CF card host controller in the SSD controller and a plurality of connections between CF and flash memory controllers, can also be selected.

In addition, the host and the SSD controller control and access the flash memories through one of transmission protocols including a SATA connection interface, a PCI Express connection interface, or a serial attached SCSI (SAS) connection interface, and transmit data by using a direct memory access (DMA) engine having a bidirectional connection port in the SSD controller.

In one embodiment, the present invention provides a SSD storage system with a parallel accessing architecture, including a SSD controller, a plurality of flash memory controllers, and a plurality of flash memories. The SSD controller is connected to an external host via a SATA bus. The SSD controller includes a microprocessor, a SATA connection interface, a DMA engine, a buffer, and a host transmission interface. The host transmission interface has a plurality of transmission interface host controllers, and the DMA engine is connected to the host connection interface via the buffer, and is connected to the host through the SATA connection interface and the SATA bus. Each of the flash memories is connected to a corresponding transmission interface host controller, and the flash memory controllers and the transmission interface host controllers are connected in parallel. The flash memory controller is connected to at least two flash memories in parallel. A plurality of independent parallel transmission channels is established between the SSD controller and the flash memory controllers connected in parallel, and data transmission between the host and the flash memories is performed through the transmission channels under control of the DMA engine.

In one embodiment, the present invention provides a SSD controller, which is connected to an external host via a high-speed serial bus connection interface, and is connected to a plurality of flash memories via a plurality of flash memory controllers. The SSD controller includes a microprocessor, a DMA engine, a buffer, a high-speed serial connection interface, and a host transmission interface. The DMA engine is connected to the microprocessor, and is controlled to be started, set and shut down by the microprocessor. The buffer is coupled to the microprocessor and the DMA engine for registering data. The high-speed serial connection interface is connected to a host connection port of the host via a connected high-speed serial bus connection interface. The host transmission interface has a plurality of transmission interface host controllers. Each of the transmission interface host controllers is connected to one of the plurality of flash memory controllers in parallel, and the flash memory controller is connected to at least two flash memories in parallel. A plurality of independent parallel transmission channels is established between the SSD controller and the flash memory controllers connected in parallel, and data transmission between the host and the flash memories is performed through the transmission channels under control of the DMA engine.

In order to make the aforementioned features and advantages of the present invention comprehensible, preferred embodiments accompanied with figures are described in detail below.

### BRIEF DESCRIPTION OF THE DRAWINGS

FIG. 1 is a schematic block diagram of the connection of a conventional storage device and a PC

FIG. 2 shows the connection to a plurality of flash memory modules using a conventional storage device of an ATA bus architecture and via a two-level shared bus.

FIG. 3 is a schematic block diagram of components of a SSD storage system according to one embodiment of the present invention.

FIG. 4 is a detailed schematic view of components of a SSD storage system according to one embodiment of the present invention.

FIG. 5A shows the signal content of the transmission interface in the MMC 4.0 protocol.

FIG. 5B is a schematic view of parallel connection architecture between the plurality of MMC transmission interfaces and the flash memory controllers.

FIG. 6A is a schematic view of the architecture of parallel connecting a MMC-flash memory controller to two parallel NAND flash memories.

FIGS. 6B and 6C are schematic views of pin signals of the MMC-flash memory controller connected the flash memories and definitions thereof respectively.

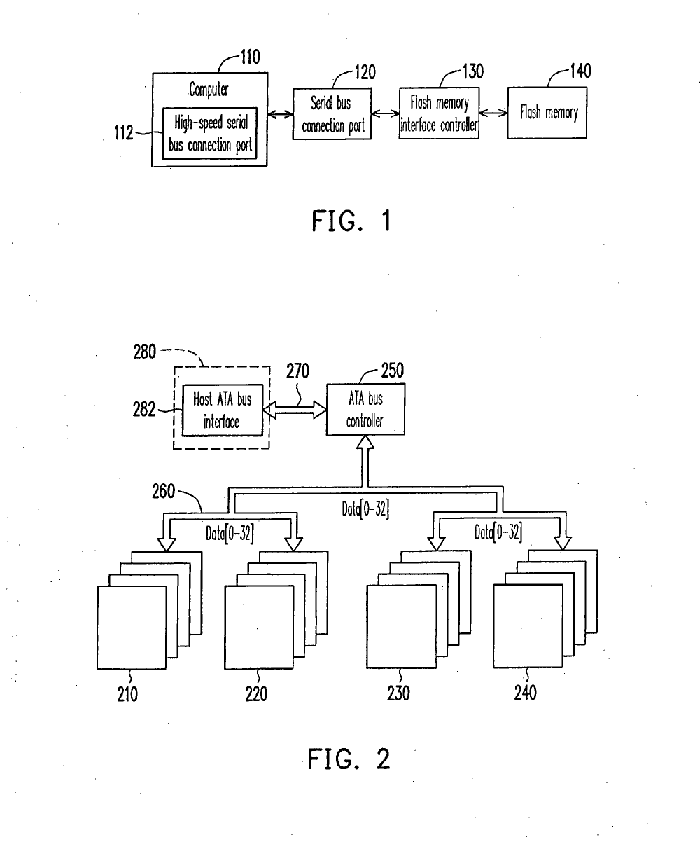

### DESCRIPTION OF EMBODIMENTS

The present invention provides a SSD storage system having a parallel accessing architecture. The SSD storage system uses flash memories as storage media. The SSD storage system of the present invention includes a SSD controller and a plurality of transmission interfaces of a predetermined bit number and bandwidth. The SSD controller forms channels for transmitting control signals and data with one or more flash memories through each of the transmission interfaces. That is, independent transmission channels are constituted between the SSD controller, the transmission interfaces with multiple bits, and the flash memories.

In the SSD storage system of the present invention, the plurality of parallel transmission channels constituted among the SSD controller, the transmission interfaces, the control interfaces and the flash memories enable the host to be connected to the SSD controller via a high-speed serial connection interface, such as a SATA connection interface, a PCI Express connection interface, or a serial attached SCSI (SAS) connection interface. The plurality of formed transmission channels are used to control and access the flash memories. The transmission channels in parallel perform data transmission under control and arbitration of the SSD controller.

The transmission interface can select to use any kind of flash memory control architecture. For example, in one embodiment, a Multimedia Card (MMC) control mechanism including a MMC host controller in the SSD controller and a MMC-flash memory controller for connecting one or more flash memories can be used. In another embodiment, a Secure Digital (SD) card control interface, including a SD card host controller in the SSD controller and a plurality of connections between SD host and SD flash memory controllers, can also be selected. In another embodiment, a Compact Flash (CF) card control interface, including a CF card host controller in the SSD controller and a plurality of connections between CF host and CF flash memory controllers, can also be selected.

Moreover, the host controls and accesses the flash memories through a high-speed serial bus connection interface and the SSD controller, and transmits data through a direct memory access engine (hereinafter referred to as DMA engine) with a bidirectional connection port in the SSD controller. The SSD controller is connected between the host and the plurality of flash memories, and parallel transmission channels are established on data bandwidth of a fixed bit number, e.g., the 8-bit data bandwidth. Moreover, the SSD controller performs data transmission by using the DMA engine.

Furthermore, the SSD storage system of the present invention has flash memory management functions, including the wear-leveling algorithm and garbage collection function of memory management in a flash translation layer (FTL) of the flash memory controller, or the low level driver (LLD), error correction code (ECC) correction function, and bad block management (BBM) function in a hardware adaptation layer of the flash memory controller.

In the SSD storage system of the present invention, the flash memories can be single level cells (SLCs) or multi level cells (MLCs). Though the accessing speed of the MLC is low, as the SSD storage system of the present invention has the parallel accessing architecture, the disadvantage can be overcome, so as to realize more extensive applications.

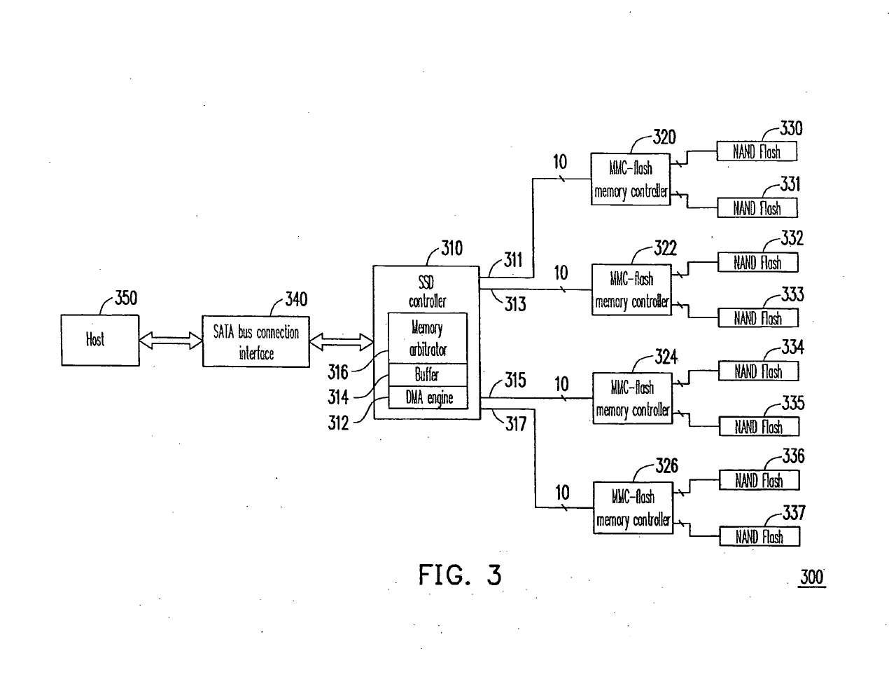

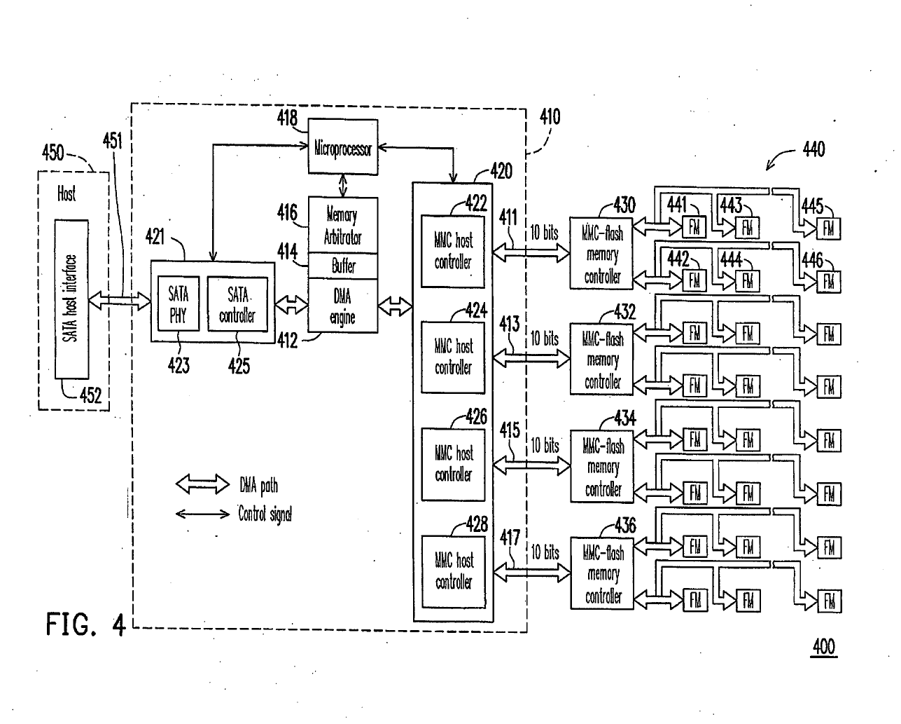

FIG. 3 is a schematic block diagram of components of a SSD storage system according to one embodiment of the present invention. Referring to FIG. 3, the SSD storage system 300 includes a SSD controller 310, a transmission interface, controllers, and flash memories. In this embodiment, a MMC transmission interface is taken as an example of the transmission interface, and NAND flash memories are taken as an example of the flash memories. However, the present invention is not limited to be so. For example, the MMC transmission interface can be replaced by a SD card control mechanism or a CF card control mechanism, as long as the SSD controller 310 and the flash memory controllers have the same interface.

Therefore, the SSD controller 310 is connected to MMC-flash memory controllers 320, 322, 324, and 326 via the transmission interface and through buses 311, 313, 315, and 317. Each of the MMC-flash memory controllers 320, 322, 324 and 326 is connected to two NAND flash memories in parallel respectively, e.g., the NAND flash memories 330-337 in FIG. 3. The SSD controller 310 is connected to a host 350 via the high-speed serial bus connection interface, e.g., a SATA bus connection interface. In other embodiments, the connection can also be realized with a PCI Express bus connection interface or a serial attached SCSI (SAS) bus connection interface. Here, only the SATA bus connection interface 340 will be discussed for the convenience of description.

The operation mode of the SSD storage system will be illustrated with the MMC-flash memory controller 320 as an example. The MMC-flash memory controller 320 is connected to the SSD controller 310 via the bus 311, and is connected to two NAND flash memories 330 and 331 in parallel. As for the two NAND flash memories 330 and 331, the host 350 establishes two accessing channels to the NAND flash memories 330 and 331 through the MMC-flash memory controller 320. The data transmission mechanism of the channels is transmitting data through a DMA engine 312 in the SSD controller 310. In this embodiment, the SSD controller 310 can include an additional memory arbitrator 316 for arbitrating the accessing authority and priority sequence of a buffer 314 at a time point.

Here, the process of data writing will be described. Assuming that the host 350 intends to write data to the NAND flash memories 330-337 currently, the SSD controller 310 is set by the internal microprocessor, and the DMA engine 312 is started. At this time, through the direct data transmission of the DMA engine 312, the data transmitted from the host 350 will be registered in the buffer 314. Then, according to the data quantity, the buffer 314 will transmit the data to one of the MMC-flash memory controllers 320-326 or to multiple MMC-flash memory controllers 320-326 at the same time in parallel. As the SSD controller 310 processes the data transmission to the MMC-flash memory controllers 320-326 in parallel, all transmission of control and data signals to any one of the MMC-flash memory controllers by the SSD controller 310 are independent, and the control and operation on the transmission by the microprocessor is not required.

Then, the process that the host reads out data will be described. Assuming that the host 350 intends to read data currently, the SSD controller 310 is set by the internal microprocessor, and the DMA engine 312 is started. At this time, the SSD controller 310 will directly read data from the NAND flash memories 330-337 through the MMC-flash memory controllers 320-326. The data are read out in parallel, and registered in the buffer 314. That is to say, the data transmissions between the SSD controller 310 and the MMC-flash memory controllers 320-326 are independent. Then, the SSD controller 310 will transmit data to the host 350 through the SATA bus connection interface 340.

In the SSD storage system of this embodiment, as the SATA bus interface with a large bandwidth is connected, the data transmission is performed by the DMA engine instead of being controlled by the microprocessor. Thus, much time is saved, and the reading and writing performance is better.

FIG. 4 is a detailed schematic view of components of a SSD storage system according to one embodiment of the present invention. The overall architecture of the SSD storage system is similar to that of FIG. 3, and only the schematic block diagram in more detail will be described.

The SSD storage system 400 includes a SSD controller 410, MMC-flash memory controllers 430-436, and a NAND flash memory array 440. The SSD controller 410 is connected to MMC-flash memory controllers 430, 432, 434, and 436 via a transmission interface and through buses 411, 413, 415, and 417. Each of the MMC-flash memory controllers 430, 432, 434, and 436 is connected to two NAND flash memories in parallel. In another embodiment, according to design requirements, each channel can be connected to one NAND flash memory or more than one NAND flash memories at the same time. Taking the MMC-flash memory controller 430 for example, one of the channels is connected to the NAND flash memories 441, 443 and 445. The other channel is connected to the NAND flash memories 442, 444 and 446.

The operation mode of the SSD storage system will be illustrated with the MMC-flash memory controller 430 as an example. The MMC-flash memory controller 430 is connected to the SSD controller 410 via the bus 411, and is connected to two rows of NAND flash memories 441-446 in parallel. As for the two rows of NAND flash memories 441-446, the host 450 establishes two accessing channels to the two rows of NAND flash memories 441-446. The data transmission mechanism of the channels is transmitting data through a DMA engine 412 in the SSD controller 410.

Besides the DMA engine 412, a buffer 414, and a memory arbitrator 416, the SSD controller 410 further includes a microprocessor 418, a MMC interface 420 and a SATA connection interface 421. The microprocessor 418 controls the operation of all internal circuits, including the DMA engine 412, the buffer 414, the memory arbitrator 416, the MMC transmission interface 420, and the SATA connection interface 421. The memory arbitrator 416 is connected to the microprocessor 418, the MMC interface 420, and the SATA connection interface 421, and is used for arbitrating the accessing authority and priority sequence to the buffer 414 at a time point.

In order to achieve the objectives of the present invention, the SSD controller forms channels for transmitting control signals and data with one or more flash memories through each of the transmission interfaces. That is to say, independent transmission channels are constituted between the SSD controller, the transmission interfaces, and the flash memories. The MMC transmission interface 420 of the SSD controller 410 includes a plurality of MMC transmission interfaces connected to the flash memory controllers in parallel, e.g., four MMC transmission interfaces 422, 424, 426, and 428 as shown in FIG. 4, each connected to the corresponding MMC-flash memory controller 430, 432, 434, or 436. The number of the MMC transmission interfaces is determined according to the number of the flash memory controllers to be connected, so as to establish independent transmission channels.

The SATA connection interface 421 includes a SATA physical layer connection interface (SATA PHY in FIG. 4) 423 and a SATA controller 425, so as to perform the transmission and communication of control signal and data with the host 450 via the SATA bus connection interface 451 and the SATA host interface 452.

Here, the process of data writing will be described. Assuming that the host 450 intends to write data to any NAND flash memory in the NAND flash memory array 440 currently, the SSD controller 410 is set by the internal microprocessor, and the DMA engine 412 is started. At this time, through the direct data transmission of the DMA engine 412, the data transmitted from the host 450 is registered in the buffer 414, and then transmitted to one of, some of, or all of the MMC-flash memory controllers 430-436 from the buffer 414 according to the data quantity. As the SSD controller 410 processes the data transmission to the MMC-flash memory controllers 430-436 in parallel, all transmissions of control and data signals to any one of the MMC-flash memories by the SSD controller 410 are independent, and the control and operation on the transmission by the microprocessor is not required. Taking the MMC-flash memory controller 430 for example, the data can be accessed from the flash memories through any one of the channels of the NAND flash memories 441 and 442 by the MMC-flash memory controller 430, or can be accessed through two channels of the memories 441 and 442 in parallel simultaneously. Or on a same channel, one of the NAND flash memories 441, 443, and 445 is accessed, or a plurality of NAND flash memories are written in an interleaving manner.

Then, the process that the host reads out data will be described. Assuming that the host 450 intends to read data currently, the SSD controller 410 is set by the internal microprocessor, and the DMA engine 412 is started. At this time, the SSD controller 410 will directly read data from the NAND flash memory array 440 through the MMC-flash memory controllers 430-436. The data are read out in parallel, and registered in the buffer 414. That is to say, the data transmissions between the SSD controller 410 and the flash memory controllers 430-436 are independent. After that, the SSD controller 410 will transmit data to the host 450 through the SATA bus connection interface 451 and the SATA host interface 452 via the SATA connection interface 421.

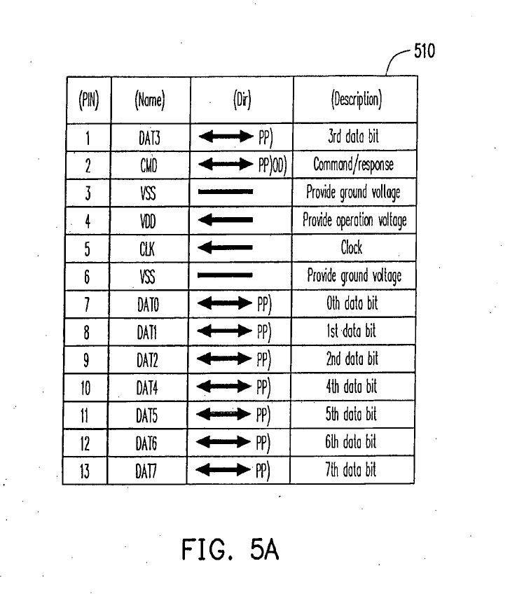

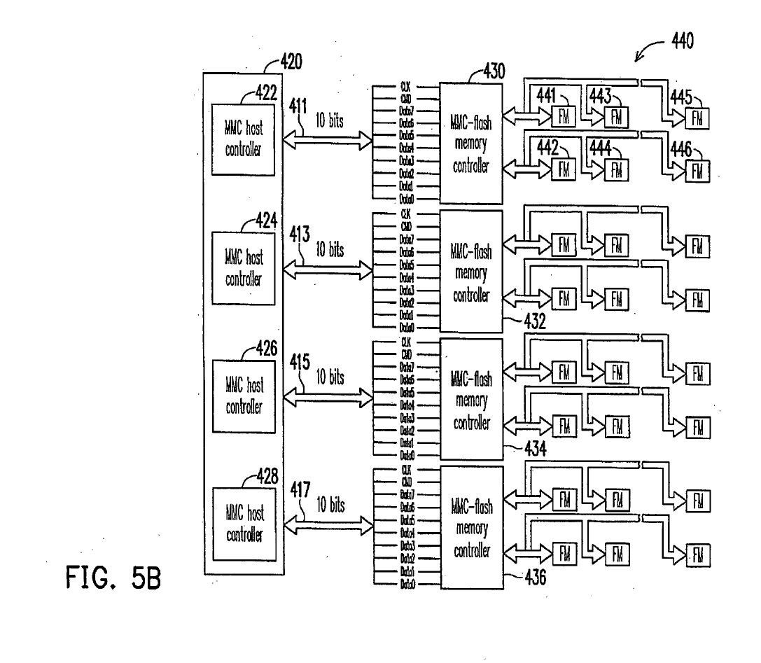

According to the MMC 4.0 protocol, the signal content of the transmission interface is as shown in Table 510 of FIG. 5A, and has 13 pins, including 8 data bit pins (Data0-Data7), a pin for providing an operation voltage VDD, a pin (CMD) for providing a command signal, a pin for a clock signal (CLK), and two pins for providing supply voltage ground. FIG. 5B is a schematic view of parallel connection architecture between the plurality of MMC transmission interfaces and the flash memory controllers. As shown in FIG. 5B, a plurality of MMC host controllers 422, 424, 426, and 428 in the MMC transmission interface 420 is connected to corresponding MMC-flash memory controllers 430, 432, 434, and 436 independently in parallel.

In the embodiment of FIG. 4, the control signal and data transmission between the MMC transmission interfaces 422, 424, 426, 428 and the corresponding MMC-flash memory controllers 430, 432, 424, 436 requires 10 bit signals among 13 pin signals of the MMC transmission interface, including a clock signal (CLK), a command signal (CMD) and data signals (8 bits of Data0-Data7), as shown in FIG. 5B.

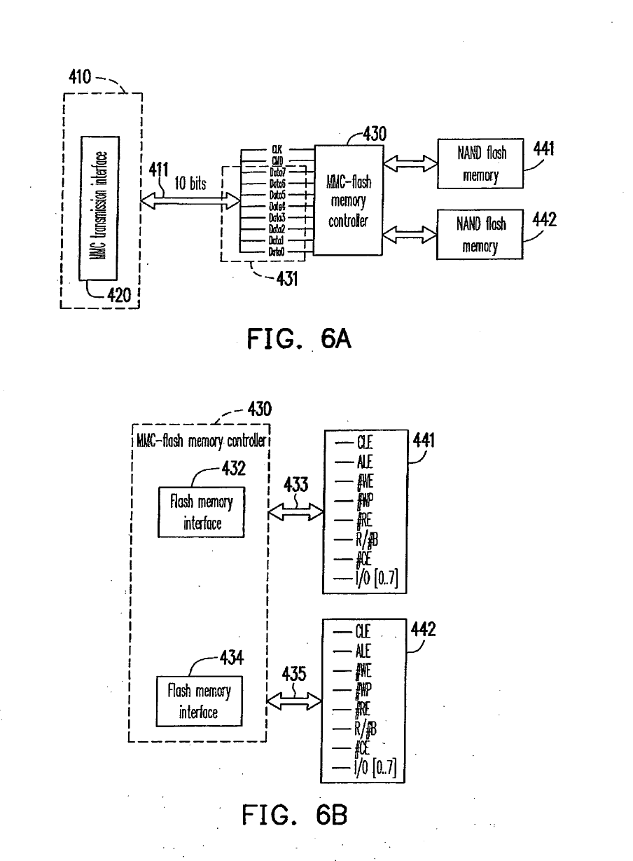

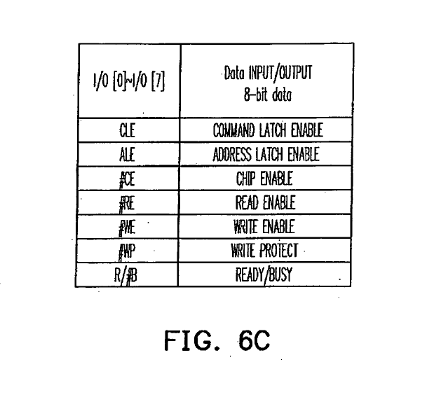

Moreover, in the embodiment of FIG. 4, the connection between the MMC-flash memory controllers 430, 432, 424, 436 and the NAND flash memory array 440 is as shown in FIGS. 6A-6C.

Firstly, in FIG. 6A, the MMC-flash memory controller 430 and the connected NAND flash memories 441 and 442 are taken as an example. The SSD controller 410 transmits 8 bits of data (Data0-Data7) to eight pins 431 of the MMC-flash memory controller 430 via the MMC transmission interface 420 and the 10-bit bus 411. Then, the MMC-flash memory controller 430 is connected to two NAND flash memories 441 and 442 in parallel via two buses 433 and 435. The buses 433 and 435 have 8 bits of data signals respectively, and are connected between the MMC-flash memory controller 430 and the NAND flash memories 441 and 442.

Therefore, in this embodiment, the established data transmission channels designate a bandwidth of fixed 8-bit data for data transmission, and the MMC-flash memory controller 430 is an architecture having one input and two parallel outputs. Moreover, whether more connection ports of parallel output are needed or not is determined according to design requirements. The MMC-flash memory controller 430 transmits the 8-bit output to more than one NAND flash memory 441. It is known from the embodiment of FIG. 4 that for the same channel, the output of the MMC-flash memory controller 430 can be written into the NAND flash memories 441, 443, or 445 and so on in an interleaving manner. The output of another channel of the MMC-flash memory controller 430 can be written into the NAND flash memories 442, 444, or 446 and so on in an interleaving manner as well. The MMC-flash memory controller 430 can access the row of NAND flash memories 441, 443 and 445 or the other row of NAND flash memories 442, 444, and 446 in parallel via two parallel output channels.

The MMC-flash memory controller 430 has flash memory management functions, including the wear-leveling algorithm and garbage collection function of memory management in a flash translation layer (FTL), or the low level driver (LLD), error correction code (ECC) correction function, and bad block management (BBM) function in a hardware adaptation layer and the like.

FIGS. 6B and 6C are schematic views for the connections between MMC-flash memory controller 430 and the NAND flash memories 441 and 442 via the buses 433 and 435 respectively. The signals received by the NAND flash memory 441 include 8 bits of data inputs/outputs I/O[0]-I/O[7] and other control signals. The control signals include a command latch enable signal CLE, an address latch enable signal (ALE), a complementary of write enable signal #WE, a complementary of write protect signal #WP, a complementary of chip enable signal #CE, a complementary of read enable signal #RE, and a complementary of ready/busy signal R/#B.

The pins of data inputs/outputs I/O[0]-I/O[7] are used to input commands, addresses and data content, and output data or state information in read operation. These I/O pins are in the high-impedance state when not used or when the outputs are disabled. The command latch enable signal CLE is used to control an activating path for command. When at a high logic level, the command will be latched in a command register in the controller on a rising edge after the complementary of write enable signal #WE is trigged. The address latch enable signal ALE is used to control an activating path for address. When at a high logic level, the address will be latched in an address register in the controller on a rising edge after the complementary of write enable signal #WE is trigged.

The complementary of chip enable signal #CE is used to control whether the flash memory is selected for operation. When the flash memory is in a busy state, the #CE signal will be ignored. Moreover, if in a program operation or erase operation, the flash memory will not return to a standby mode. The complementary of read enable signal #RE is a serial data-out control. After #RE becomes active, the data can be transmitted from the data inputs/outputs pins I/O[0] to I/O[7].

The complementary of write enable signal #WE is used to control whether to write the data from the inputs/outputs pins. The command, address and data can be latched when the #WE signal is on the rising edge. The complementary of write protect signal #WP is used to control improper program or erase operation during power conversion. When the #WP signal is in a logic low state, data cannot be written into the flash memory. The complementary of ready/busy signal R/#B is used to indicate the operating state of the flash memory. When the R/#B signal is in a logic low state, it is indicated that the flash memory is busy at internal data accessing, data erasing or other operation, and the R/#B signal will return to a logic high state when the operation is over. However, it should be noted that the operations of the NAND flash memory may have different operation modes and settings according to different designs or modifications.

To sum up, this embodiment describes a SSD storage system having a parallel accessing architecture. The SSD storage system includes a SSD controller, a MMC 4.0 or higher transmission interface, flash memory controllers compatible with the MMC interface, and flash memories. In this embodiment, the SSD controller has independent and parallel processing transmission channels. Each of the transmission channels includes a MMC transmission interface and a flash memory controller connected in parallel, and each of the flash memory controllers is connected to at least two flash memories in parallel. Here, the MMC 4.0 transmission interface is selected because of its 8-bit data transmission bandwidth, including a pin of operation voltage VDD, a pin for providing a command signal CMD, a pin of clock signal CLK, and eight pins of data bits (Data0-Data7). However, in order to realize one option of the present invention, other forms of transmission interfaces can also be used, as long as their connection bus can include fixed data bits for establishing the independent and parallel processing transmission channels described above. However, the bit number of data transmission or the bandwidth must be compatible with the bit number or the bandwidth of data transmission interface of the flash memory controllers.

In addition, as for the flash memory controllers connected to the SSD controller in parallel, two flash memories controlled by each of the flash memory controllers to transmit control signals and data and connected in parallel are used in this embodiment. However, the number of the flash memories is not limited to be so. Considering the overall performance and data transmission efficiency, two flash memories or two rows of flash memories connected in parallel are preferred.

Moreover, the SSD controller of this embodiment uses the DMA engine having a bidirectional connection port in the SSD controller to transmit data. Therefore, the transmission of all control and data signals to any flash memory controller by the SSD controller 310 is performed independently, and the control and operation on the transmission by the microprocessor is not required. Thus, less resource is occupied, and the overall efficiency is improved.

Moreover, the flash memory controllers of this embodiment has flash memory management functions, including the wear-leveling algorithm and garbage collection function of memory management in a flash translation layer (FTL), or the low level driver (LLD), error correction code (ECC) correction function, and bad block management (BBM) function in a hardware adaptation layer and the like. Therefore, the life of the flash memories can be prolonged significantly, less microprocessor resource is occupied, and the overall efficiency is improved.

It will be apparent to persons of ordinary in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A solid state disk (SSD) storage system, comprising:
a SSD controller, connected to an external host via a high-speed serial connection interface, and comprising a microprocessor, a direct memory access (DMA) engine, a buffer, and a host transmission interface, wherein the host transmission interface has a plurality of transmission interface host controllers, and the DMA engine is connected to the buffer, and is connected to the host via the high-speed serial connection interface;
a plurality of flash memory controllers, wherein each of the flash memory controllers is connected to corresponding one of the plurality of the transmission interface host controllers, and the flash memory controllers are connected to the transmission interface host controllers in parallel; and
a plurality of flash memories, wherein the flash memory controller is connected to at least two of the flash memories in parallel,
wherein a plurality of independent parallel transmission channels are established between the SSD controller and the flash memory controllers, and data transmission between the host and the flash memories is performed through the transmission channels under control of the DMA engine.

2. The SSD storage system as claimed in claim 1, wherein the high-speed serial connection interface is a SATA connection interface.

3. The SSD storage system as claimed in claim 1, wherein the high-speed serial connection interface is a PCI Express connection interface.

4. The SSD storage system as claimed in claim 1, wherein the high-speed serial connection interface is a serial attached SCSI (SAS) connection interface.

5. The SSD storage system as claimed in claim 1, wherein the SSD controller further comprises a memory arbitrator connected to the microprocessor and the host transmission interface, for arbitrating a priority sequence that the buffer to be accessed by the microprocessor or the host transmission interface.

6. The SSD storage system as claimed in claim 1, wherein the host transmission interface is a MMC interface, the transmission interface host controller is a MMC host controller, and the flash memory controller is a MMC-flash memory controller.

7. The SSD storage system as claimed in claim 1, wherein the host transmission interface is one of a SD card control interface or a CF card control interface.

8. The SSD storage system as claimed in claim 1, wherein data transmission buses between the transmission interface host controllers and the flash memory controllers comprise 8-bit data buses, and 8-bit data buses are also arranged between the flash memory controllers and the flash memories connected in parallel.

9. The SSD storage system as claimed in claim 1, wherein when the SSD controller receives an accessing request signal from the host, the microprocessor starts and sets the DMA engine, such that the DMA engine controls the data transmission between the host and the flash memories through the transmission channels.

10. The SSD storage system as claimed in claim 1, wherein the flash memory controller further comprises a wear-leveling function, an error correction code (ECC) function, a garbage collection function, a bad block management (BBM) function or a combination thereof.

11. The SSD storage system as claimed in claim 1, wherein a control signal and a data signal are included in buses connecting the flash memory controllers to the flash memories, the data signal has 8 bits, and the control signal comprises a command latch enable signal, an address latch enable signal, a write enable inversion signal, a write protect inversion signal, a complementary of chip enable signal, a read enable inversion signal, and a ready/busy inversion signal.

12. A solid state disk (SSD) storage system, comprising:
a SSD controller, connected to an external host via a high-speed serial connection interface, and comprising a microprocessor, a direct memory access (DMA) engine, a buffer, and a host transmission interface, wherein the host transmission interface has a plurality of transmission interface host controllers, and the DMA engine is connected to the buffer, and is connected to the host via the high-speed serial connection interface;
a plurality of flash memory controllers, wherein each of the flash memory controllers is connected to corresponding one of the transmission interface host controllers, and the flash memory controllers are connected to the transmission interface host controllers in parallel; and
a flash memory array, comprising a plurality of rows of flash memories, wherein at least two rows of the flash memories are connected to the flash memory controller in parallel,
wherein a plurality of independent parallel transmission channels are established between the SSD controller and the flash memory controllers, and data transmission between the host and the flash memory array is performed through the transmission channels under control of the DMA engine.

13. The SSD storage system as claimed in claim 12, wherein the host writes data into the plurality of flash memories of the flash memory row in an interleaving manner.

14. The SSD storage system as claimed in claim 12, wherein the host accesses the flash memory rows in parallel simultaneously.

15. The SSD storage system as claimed in claim 12, wherein the high-speed serial connection interface is one of a SATA connection interface, a PCI Express connection interface, or a serial attached SCSI (SAS) connection interface.

16. The SSD storage system as claimed in claim 12, wherein the host transmission interface is a MMC 4.0 or higher interface, the transmission interface host controller is a MMC host controller, and the flash memory controller is a MMC-flash memory controller.

17. The SSD storage system as claimed in claim 12, wherein data transmission buses between the transmission interface host controllers and the flash memory controllers comprise 8-bit data buses, and 8-bit data buses are also arranged between the flash memory controllers and the flash memory rows connected in parallel.

18. The SSD storage system as claimed in claim 12, wherein when the SSD controller receives an accessing request signal from the host, the microprocessor starts and sets the DMA engine, such that the DMA engine controls the data transmission between the host and the flash memory rows through the transmission channels.

19. The SSD storage system as claimed in claim 12, wherein the high-speed serial connection interface is a SATA connection interface, and the SSD controller further comprises a SATA physical layer connection interface and a SATA controller, such that the SSD controller is connected to a SATA bus connection interface, so as to connect to a SATA host interface of the host.

20. The SSD storage system as claimed in claim 12, wherein the flash memory controller further comprises a wear-leveling function, an error correction code (ECC) function, a garbage collection function, a bad block management (BBM) function or a combination thereof.

21. A solid state disk (SSD) controller, connected to an external host via a high-speed serial bus connection interface, and connected to a plurality of flash memories via a plurality of flash memory controllers, the SSD controller comprising:
a microprocessor;
a DMA engine, connected to the microprocessor for being controlled to be started, set and shut down by the microprocessor;
a buffer, coupled to the microprocessor and the DMA engine, for registering data;
a high-speed serial connection interface, connected to a host connection port of the host via the connected high-speed serial bus connection interface; and
a host transmission interface, having a plurality of transmission interface host controllers, wherein each of the transmission interface host controllers is connected to one of the flash memory controllers in parallel, and the flash memory controller is connected to at least two flash memories in parallel, and a plurality of independent parallel transmission channels are established between the SSD controller and the flash memory controllers, and data transmission between the host and the flash memories is performed through the transmission channels under control of the DMA engine.

22. The SSD controller as claimed in claim 21, wherein the high-speed serial connection interface is one of a SATA connection interface, a PCI Express connection interface, or a SAS connection interface.

23. The SSD controller as claimed in claim 21, further comprising a memory arbitrator connected to the high-speed serial connection interface, the microprocessor, and the host transmission interface, for arbitrating a priority sequence that the buffer to be accessed by the high-speed serial connection interface, the microprocessor, or the host transmission interface.

24. The SSD controller as claimed in claim 21, wherein the host transmission interface is a MMC interface, the transmission interface host controller is a MMC host controller, and the flash memory controller is a MMC-flash memory controller.

25. The SSD controller as claimed in claim 21, wherein data transmission buses between the transmission interface host controllers and the flash memory controllers comprise 8-bit data buses, and 8-bit data buses are also arranged between the flash memory controller and the flash memories connected in parallel.
